(19) United States
(12) Patent Application Publication
(10) Pub. No.: US 2019/0325442 A1
(43) Pub. Date: Oct. 24, 2019

(54) SYSTEMS AND METHODS FOR SECURELY LINKING FINANCIAL ACCOUNTS TO TRANSFER FUNDS AND MONITOR ACCOUNT ACTIVITY

(71) Applicant: CAPITAL ONE SERVICES, LLC, McLean, VA (US)

(72) Inventors: Carrie Norman, Frisco, TX (US); Joshua S. Edwards, Philadelphia, PA (US)

(73) Assignee: Capital One Services, LLC.

(21) Appl. No.: 15/960,997

(22) Filed: Apr. 24, 2018

Related U.S. Application Data
(63) Continuation of application No. 15/958,071, filed on Apr. 20, 2018.

(51) Int. Cl. G06Q 20/40; G06Q 20/10

(52) U.S. Cl. CPC G06Q 20/405; G06Q 20/10

(57) ABSTRACT

The disclosed embodiments provide systems, methods, and techniques for securely linking financial accounts in order to enable the transfer of funds and the monitoring of activity in the linked accounts. A request to link a first account with a second account may be received from an interface of a user device. An authorization may be received to link the first account with the second account. A transfer request may be received, including a request to transfer funds from the first account to the second account based on a set of transfer rules. The second account may be monitored for qualifying transactions, and upon determining that a qualifying transaction has occurred, funds may be transferred from the first account to the second account based on the transfer rules from the first account to the second account.

### TECHNICAL FIELD

The disclosed embodiments generally relate to systems and methods for securely linking and sharing data between one or more systems to enable the secure transfer of funds between financial accounts. More specifically, the disclosed embodiments relate to securely linking and granting access to account information to enable the monitoring of activity in a first account from a second account, and to enable transferring of funds from the second account to the first account based on activity in the first account.

### BACKGROUND

A common service offered by most modern financial institutions is the ability to initiate the electronic transfer of funds in and out of an account. Most financial institutions provide several options for doing so. These include, among others, enabling account owners to enroll in automatic bill payment programs, initiate transfers between a user's accounts, and transfer funds to outside accounts or recipients. Generally, account owners are electronically provided these functions without the need for teller services. The functions are generally available via a mobile banking application or online web interface.

While these banking functions are useful for enabling funds to be electronically transferred without the need for paper checks or teller support, they are generally limited to certain transactions. These include one-off transfers or recurring transfers to preset payees with preset transfer amounts. In particular, most methods of electronically transferring funds available to account owners are generally limited to transfers of a set funds amount scheduled on a particular date, or transfers as part of a recurring bill pay process with known amounts and dates. The ability to automatically transfer funds between accounts beyond these is limited. Even more limited is the ability to establish automatic transfers from one account based on activity (e.g., deposits or transfers) in another account.

For example, traditional banking functions generally rely on limited set of rules created in a customer's account, and base transfers on activity in that account. These rules typically include automatic bill pay rules, overdraft rules to prevent negative balances, and single-use or recurring transfer rules between a customer's accounts (e.g., between savings and checking accounts), transfer rules to outside accounts, or transfer rules to particular recipients. While all of these functions may require authorization from the customer, they rely solely on the customer's own account and cannot alter the rules based on activity in an outside account. In automatic bill payments, for example, a customer can specify a transfer of funds (e.g., make a payment) in any amount to a designated recipient (e.g., a utility company, etc.). This may require invoice information from the receiver, but the amount transferred is not dependent on activity in the receiver's account (i.e., in the utility company's account). In a single-use or recurring transfer example, a customer may request a transfer of funds, but it is either a one-time request for a specified amount or it is a recurring request for a specified amount. No dynamic alterations can be made to the transferred amount based on the receiver's account.

Therefore, current systems and processes fail to provide banking institution account owners the ability to electronically transfer funds based on activity in another account, including those owned (or jointly-owned) by other customers or in different financial institutions. This type of activity can be useful, for instance, to match savings deposits made in a first account by transferring funds from a second account to the first account based on the amount deposited in the first account. In other instances, the ability to transfer funds based on activity in another account may be useful for transactions other than deposits in the recipient's account. For example, it may be useful to monitor outgoing transfers (e.g., payments) in the other account and automatically transfer money to that account. Example scenarios include shared bills between parties, in which one party automatically pays a second party a portion of a bill (e.g., 50% of the rent and utilities, etc.) when the second party makes the payment (e.g., when the first account transfers money out to pay the bill, the second account transfers an amount equivalent to a portion of the bill to the first account).

Accordingly, improvements in the ability to link account activity in a first account and create transfer rules from a second account based on activity in the first account is needed, including accounts with different ownership, those provided by different financial institutions, and different account types.

Further still, improvements in the ability to link accounts of different account owners and across different financial institutions is desired. In order to initiate transfers from a first account to a second account based on activity in the second account, owners of those accounts and financial institutions providing the accounts must enable access to information between the accounts. Access may include the ability to monitor activity in the second account by the owner of the first account while maintaining the security of account (e.g., preventing unauthorized withdrawals, etc.), the security of account information (e.g., protecting full account numbers, etc.) and personally identifiable information (e.g., protecting the account holder's personal information) between accounts. Obtaining authorizations to access another's account details and closely protecting that data is essential to maintaining security of both accounts and to personal information of the different account owners. The present methods enable, among other things, a transferor account owner to view select transactions and details in a transferee account. Moreover, the transferor account owner may be provided with statements including certain activity in the transferee account, which enables the transferor account owner to verify and monitor transfers to the transferee account. This requires establishing access privileges, maintaining data security, and obfuscating certain personal data that is unnecessary for the transferor to view (and vice versa).

In view of these and other shortcomings and problems in existing transfer methods, improved systems and methods are disclosed for enabling secure, automatic electronic transfers from a first account to a second account, where funds may be transferred from the first account based on activity in the second account. In particular, funds may be transferred from the first account to the second account based on savings activities in the second account. In some embodiments, funds may also be transferred from the first account to the second account based on other activity, including transfers in and out of the second account. The novel systems and methods may also enable accounts to be linked across customers, institutions, and account types, while maintaining data security and access to necessary information. Electronic transfers are disclosed within a single financial institution, between different institutions, and additionally using a third-party service provider to link two accounts and share information between account owners, whether the accounts are within the same financial institution or separate financial institutions.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The disclosed embodiments address disadvantages of existing systems by providing improved systems and methods for transferring funds from a first account to a second account. Unlike any prior implementations, the disclosed systems and methods improve the ability to automatically or semi-automatically transfer funds from a first account to a second account based on activity (e.g., deposits and/or transfers) in the second account. For example, the disclosed embodiments disclose techniques of linking accounts and enabling the transfer of funds based on activity in one or more of the linked accounts.

To provide these improvements, the disclosed systems and methods may be implemented using a combination of hardware, firmware, and/or software, as well as specialized hardware, firmware, and/or software, such as a machine constructed and/or programmed specifically for performing functions associated with the disclosed method steps. However, in some embodiments, disclosed systems and methods may be implemented instead by dedicated hardware.

Certain disclosed embodiments provide systems for transferring funds from a first account to a second account, which may comprise one or more memory devices storing instructions, and one or more processors configured to execute the instructions to perform operations. The operations may comprise providing an interface accessible via a user device registered with the first account. The operations may further comprise receiving, via the interface, a request to link the first account with the second account, and receiving, based on the request, an authorization associated with the second account to link the first account with the second account. The operations may further comprise linking, based on the authorization, the first account with the second account. Further, the operations may comprise receiving, via the interface, a transfer request, the transfer request comprising a request to transfer funds from the first account to the second account when the second account receives a deposit, monitoring the second account for a deposit, and determining that a qualifying transaction has been made to the second account. Upon detection of the qualifying transaction, the operations may comprise transferring funds, based on an amount of the determined transaction from the first account to the second account, and providing, via the interface, a first notice, the first notice stating that the funds have been transferred.

Other disclosed embodiments provide systems for transferring funds from a first account to a second account, which may comprise one or more memory devices storing instructions, and one or more processors configured to execute the instructions to perform operations. The operations may comprise providing a first interface accessible via a user device registered with the first account, the first interface comprising a set of selectable rules for transferring funds to the second account. Further, the operations may comprise receiving, via the first interface, a selection of a rule. The operations may further comprise providing a second interface accessible via a user device registered with the second account, the first account and second account being linked and the second account applying the selected rule. Further operations may comprise receiving, via the first interface, a transfer request, the transfer request comprising a request to initiate an automatic transfer of funds from the first account to the second account for qualifying transactions in the second account, monitoring the second account for a qualifying transaction, and determining that a qualifying transaction has been made to the second account. Upon detection of the qualifying transaction, the operations may comprise transferring funds, based on an amount of the determined transaction and the selected rule from the first account to the second account, and providing, via the first interface, a first notice, the first notice stating that the funds have been transferred.

Aspects of the disclosed embodiments may also include a tangible, non-transitory, computer-readable medium that stores software instructions that, when executed by one or more processors, are configured for and capable of performing and executing one or more of the methods, operations, and the like consistent with the disclosed embodiments.

It is to be understood that both the foregoing general description and the following detailed description are exemplary and explanatory only, and are not restrictive of the disclosed embodiments as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system environment, consistent with disclosed embodiments;

FIG. 2A is a block diagram of an exemplary method of linking financial accounts, consistent with disclosed embodiments;

FIG. 2B is a block diagram of an exemplary method of linking financial accounts, consistent with disclosed embodiments;

FIG. 2C is a block diagram of an exemplary method of linking financial accounts, consistent with disclosed embodiments;

FIG. 2D is a block diagram of an exemplary method of linking financial accounts, consistent with disclosed embodiments;

FIG. 3 is a flow chart of an exemplary method of linking financial accounts, consistent with disclosed embodiments;

FIG. 4 is a flow chart of an exemplary method of monitoring activity in another account and transferring funds based on that activity, consistent with disclosed embodiments;

FIG. 5 illustrates an exemplary graphical user interface displaying an authorization to link financial accounts, consistent with disclosed embodiments;

FIG. 6 illustrates an exemplary graphical user interface displaying an request to authorize transfer of funds to another account based on activity in that account, consistent with disclosed embodiments; and

FIG. 7 illustrates an exemplary graphical user interface displaying a summary of transfers and transfer rules based on activity in another account, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The disclosed embodiments generally relate to systems and methods for transferring funds from a first account based on activity in a second account. In particular, the disclosed embodiments relate to systems and methods that enable a first financial account and financial second account to be linked such that the first account may monitor activity (e.g., deposits, withdrawals, etc.) in the second account, and funds may be automatically transferred between the accounts based on activity in the second account. In an exemplary embodiment, the two financial accounts are linked and a deposit in the first account triggers a transfer of funds from the second account based on the deposit amount in the first account. The transfer of funds is determined based on a set of rules, privileges between accounts, secure links, and electronic transfer rules. Information about each account is securely shared. These functions may be provided by a financial institution and/or third-party service provider acting as an intermediary, while account owners can view and control the transfers and account linking using an interface provided on a user device.

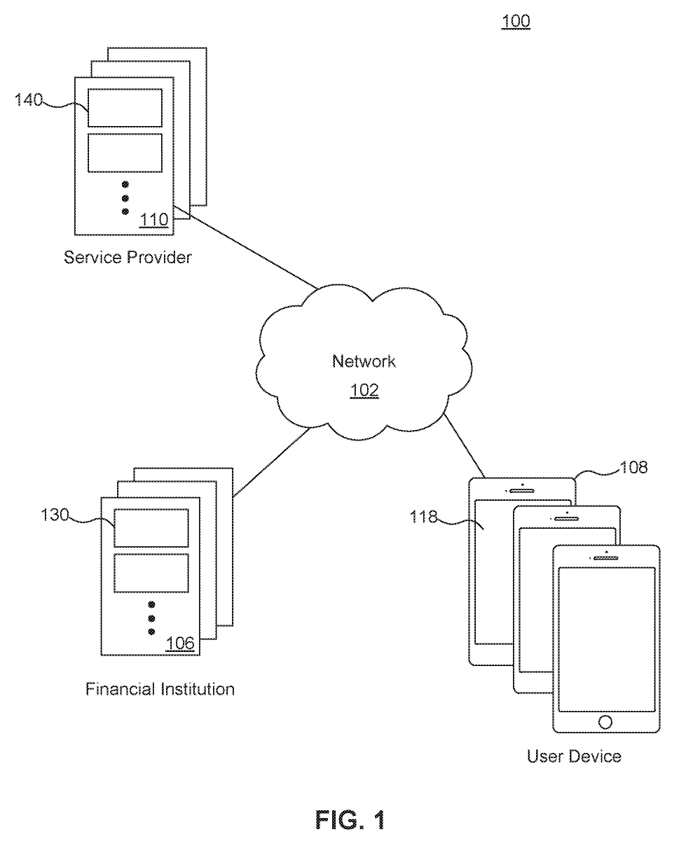

FIG. 1 is a diagram illustrating exemplary system environment 100 in accordance with the disclosed embodiments. The components and arrangements shown in FIG. 1 are not intended to limit the disclosed embodiments, as the components used to implement the disclosed processes and features may vary. System environment 100 may include one or more networks 102, financial institutions 106, third-party service providers 110, and user devices 108. Each of the networks 102, financial institutions 106, and third-party service providers 110 may comprise one or more computing devices or servers, databases, cloud services, and/or internal networks. Other components known to one of ordinary skill in the art may be included in system environment 100 to gather, process, transmit, receive, acquire, and provide information used in conjunction with the disclosed embodiments. In addition, system environment 100 may further include other components that perform or assist in the performance of one or more processes that are consistent with the disclosed embodiments.

In some embodiments, system environment 100 may include one or more networks 102. Network 102 may comprise any computer networking arrangement used to exchange data. For example, network 102 may be the Internet, a private data network, a virtual private network (VPN) using a public network, and/or other suitable connections that enable the components of system environment 100 to send and acquire information. Network 102 may also include a public switched telephone network (“PSTN”) and/or a wireless network such as a cellular network, wired Wide Area Network, Wi-Fi network, and/or another known wireless network (e.g., WiMAX) capable of bidirectional data transmission.

Each network 102, financial institution 106, and third-party service provider 110 may also include one or more local networks (not pictured). A local network may be used to connect the components of FIG. 1, such as financial institution 106, user device 108, and third-party service provider 110 to network 102. A local network may comprise any type of computer networking arrangement used to exchange data in a localized area, such as Ethernet, Wi-Fi based on IEEE 802.11 standards, Bluetooth™, and other suitable network protocols that enable components of system environment 100 and other servers, computers, and systems of components of system environment 100 to interact with one another and to connect to network 102. In some embodiments, a local network comprises a portion of network 102. In other embodiments, components of system environment 100 may communicate via network 102 without a separate local network.

In some embodiments, system environment 100 may include one or more user devices 108. User device 108 may be one or more of a desktop computer, a laptop, a tablet, a smartphone, a multifunctional watch, a pair of multifunctional glasses, a tracking device, or any suitable device with computing capability. User device 108 may comprise a memory, a processor, and/or other specialized hardware that is configured to execute one or more methods of the disclosed embodiments. User device 108 may have an application installed thereon, which may enable user device 108 to communicate with, for example, with financial institution 106 and/or third-party service provider 110 via network 102 and/or a local network. Additionally, user device 108 may connect to financial institution 106 and/or third-party service provider 110 through use of web browser software via network 102 and/or a local network. Finally, user device 108 may provide a graphical user interface 118 to enable users to view data from the user device 108 generated by an application thereon and obtained over network 102 from one or more of financial institution 106 and/or third-party service provider 110.

In some embodiments, one or more of financial institution 106, third-party service provider 110, and/or network 102 may include one or more databases. Database may include one or more memory devices that store information. By way of example, databases may include Oracle™ databases, Sybase™ databases, or other relational databases or non-relational databases, such as Hadoop sequence files, HBase™, or Cassandra™. The databases or other files may include, for example, data and information related to the source and destination of a network request, the data contained in the request, etc. Systems and methods of disclosed embodiments, however, are not limited to separate databases. Database may include computing components (e.g., database management system, database server, etc.) configured to acquire and process requests for data stored in memory devices of database and to provide data from database.

In some embodiments, one or more of financial institution 106, third-party service provider 110, and/or network 102 may include one or more cloud services. Cloud service may include a physical and/or virtual storage system associated with cloud storage for storing data and providing access to data via a public network such as the Internet. Cloud service may include cloud services such as those offered by, for example, Amazon®, Apple®, Cisco®, Citrix®, IBM®, Joyent®, Google®, Microsoft®, Rackspace®, Salesforce.com®, and Verizon®/Terremark®, or other types of cloud services accessible via network 102. In some embodiments, cloud service comprises multiple computer systems spanning multiple locations and having multiple databases or multiple geographic locations associated with a single or multiple cloud storage service(s). As used herein, cloud service refers to physical and virtual infrastructure associated with a single cloud storage service and may manage and/or store data.

In some embodiments, one or more of financial institution 106, third-party service provider 110, and/or network 102 may include one or more servers or clusters of servers. Servers or clusters of servers may be located in the same data center or different physical locations. Multiple servers and clusters may be formed as a grid to share resources and workloads. Each server and/or cluster may include a plurality of linked nodes operating collaboratively to run various applications, software modules, analytical modules, rule engines, etc. Each node may be implemented using a variety of different equipment, such as a supercomputer, personal computer, a server, a mainframe, a mobile device, or the like. In some embodiments, the number of servers and/or server cluster may be expanded or reduced based on workload. In some embodiments, one or more components of system environment 100 may be placed behind a load balancer to support high availability and ensure real-time (or near real-time) processing of optimal decision predictions.

In some embodiments, one or more of financial institution 106, third-party service provider 110, and/or network 102 may include one or more computing systems that are configured to execute software instructions stored on one or more memory devices to perform one or more operations consistent with disclosed embodiments. For example, a financial institution 106 may include memory devices storing data and software instructions and processors configured to use the data and execute the software instructions to perform server-based functions and operations known to those skilled in the art. Financial institution 106 may also include one or more general-purpose computers, mainframe computers, or any combination of these types of components. In some embodiments, financial institution 106 may have an application installed thereon to perform processes that are consistent with disclosed embodiments.

In some embodiments, one or more of financial institution 106, third-party service provider 110, and/or network 102 may include devices configured as a particular apparatus, system, or the like based on the storage, execution, and/or implementation of the software instructions that perform operations consistent with disclosed embodiments. Devices of financial institution 106 may be standalone, or may be part of a subsystem included in a larger system. For example, financial institution 106 may include distributed servers that are remotely located and communicate over a network (e.g., WAN and/or a local network) or a dedicated network.

In some embodiments, one or more of financial institution 106, third-party service provider 110, and/or network 102 may include or may access one or more storage devices configured to store data and/or software instructions used by one or more processors to perform operations consistent with disclosed embodiments. For example, financial institution 106 may include memory configured to store one or more software programs that perform several functions when executed by a processor. The disclosed embodiments are not limited to separate programs or computers configured to perform dedicated tasks. For example, financial institution 106 may include memory that stores a single program or multiple programs. Additionally, one or more of financial institution 106, third-party service provider 110, and/or network 102 may execute one or more programs located remotely. For example, financial institution 106 may access one or more remote programs stored in memory included with a remote component that, when executed, perform operations consistent with disclosed embodiments. For example, financial institution 106 may exchange data and interact with systems, devices, and programs of third-party service provider 110 and/or hardware and software of user device 108. In certain aspects, one or more of financial institution 106, third-party service provider 110, and/or network 102 may include server software that generates, maintains, and provides services associated with user accounts.

Financial institution 106 in system environment 100 may include any entity that generates, provides, manages, and/or maintains financial service accounts 130, etc., for customers. Financial institution 106 may include a retail and commercial bank, internet bank, credit union, savings and loan association, investment bank or company, brokerage firm, and/or another financial institution known by those of skill in the art. Financial institution 106 may provide and maintain one or more financial service accounts 130 for an account owner. The one or more accounts 130 may include, among others types, a checking account, a savings account, certificate of deposit account, money market account, brokerage account, investment retirement account (IRA), 401(k) account, and/or any other financial account known by those of skill in the art. System environment 100 may include more than one financial institution 106 with one or more financial accounts 130, a single financial institution 106 with two or more financial accounts 130, or any other combination thereof. In the context of the disclosed embodiments, the present embodiments include a first account and second account, including those situated in one or more financial institutions, owned by one or more account owners, and of one or more account type.

Each financial account 130 in system 100 may have differing or overlapping account ownership and access privileges. For example, the financial accounts 130 may be individual accounts, joint accounts, payable-on-death accounts, joint account with rights of survivorship, accounts in trust, or any other type of account ownership known by those of skill in the art. For example, an individual account may include a singular account owner. A joint account may include two or more account owners with equal access to funds and information related to the account. Accounts in trust may be controlled by a designated trustee for the benefit of another account owner, who may have limited access or control over the trust account. It is not desired to limit the type of financial account 130 used in the present embodiments.

Third-party service provider 110 may be any company, organization, or entity that may enable, monitor, coordinate, and/or control access and provide information to different account owners of different financial accounts 130 in system environment 100. Third-party service provider 110 may communicate with one or more financial institutions 110 and one or more customers via one or more user devices 108, and enable access to account information and manage access rights to different financial accounts 130. Third-party service provider 110 may serve as an information clearinghouse or intermediary between financial institution 106 and user device 108. For example, account owners may grant third-party service provider 110 access to certain information for financial accounts 130 maintained by one or more financial institution 106. Financial institution 106 may securely publish data to third-party service provider 110 for particular financial accounts whose owners have granted access, and particular data from those accounts, over a secure protocol or public or private network, and third-party service provider 110 may control access to the information between different account owners. In one embodiment, account owner of financial account 130 may grant access to information from the account, whereby financial institution 106 enables third-party service provider 110 to access account data via an application programming interface (API) or some other means, and share data with an owner of another financial account. The two accounts are thereby linked by third-party service provider 110 having access to certain data in each account and publishing that data to the different account owners. This enables, for instance, an owner of a first account to see transactions in a second account. Certain personal and financial data may be obfuscated or not shared by third-party service provider 110, or financial institution 106 may not provide such information, upon request and based on the scope of access enabled by an account owner. These data sharing functions may also be carried out, in certain embodiments, by one or more financial institution 106 directly with account owners and without third-party service provider 110.

As will be discussed in greater detail below, account owners may establish rules to transfer money from a first account and to a second account based on activity in the first account. Rules may be established and stored in an account owner's financial account 130 by financial institution 106, in a service account 140 of third-party service provider 110, or both. Rules may be established by account owners via graphical user interface 118 of user device 108 for, among other things, determining when to transfer funds, determining how much to transfer, and determining what restrictions are placed on transferred funds, transfer amounts, and transfer rates.

One or more financial institutions 106 and/or one or more third-party service providers 110 may host a web application, API, web site, or similar interface that is accessible over network 102 to account owners via user device 108. The interface may be hosted on one or more web servers and operate in a client-server model with user device 108, while obtaining information, including account information, from service provider 110 and/or financial institution 106. Via user device 108, an account owner may view graphical user interface 118 on user device 108. Graphical user interface 118 may provide account owners with the ability to view financial account information of another account, e.g., another account owner's account. Graphical user interface 118 may also provide an interface enabling the disclosed functions herein, including, among other things, authorizations to transfer funds, authorizations to share information and link financial accounts, establish rules for transferring funds between linked accounts, and track and monitor transfers and the status of financial accounts.

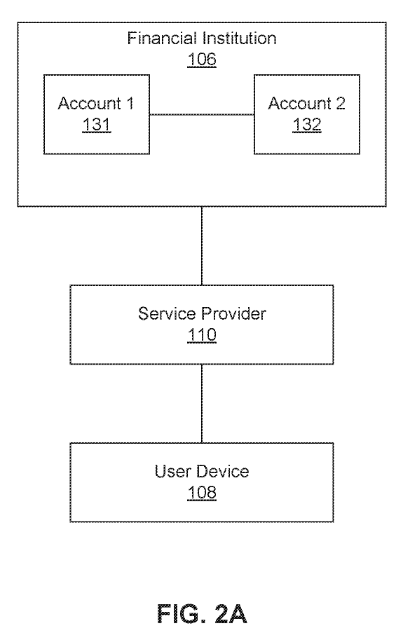

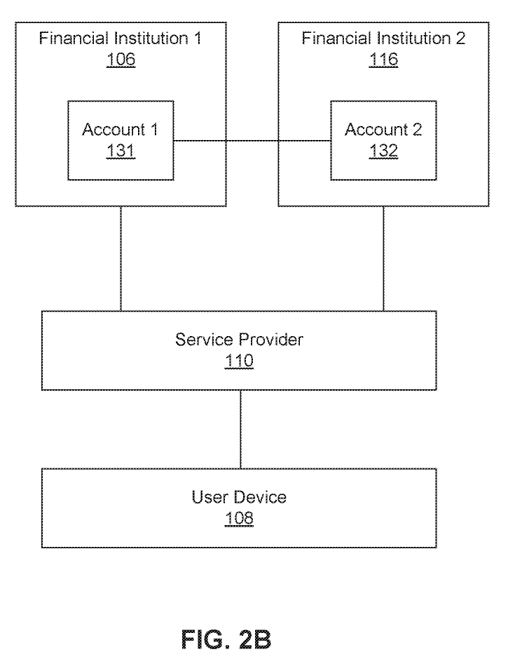

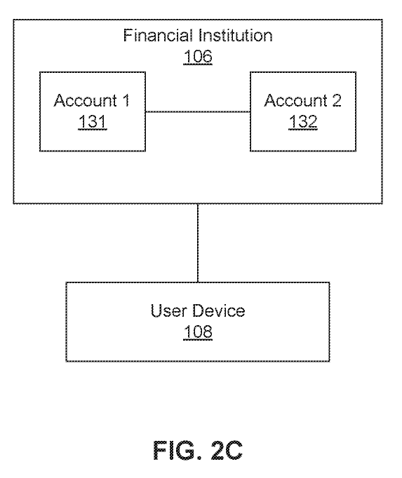

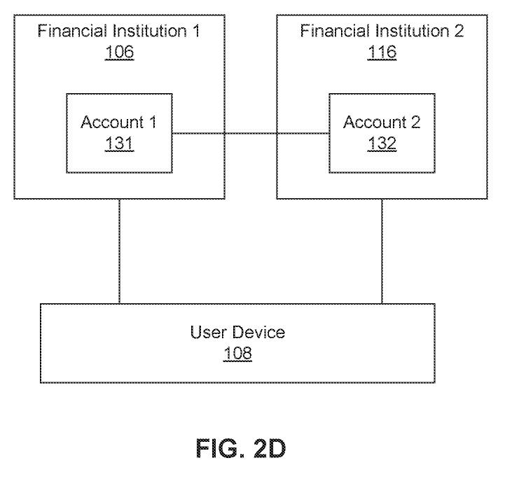

FIGS. 2A-2D provide various embodiments of the present disclosure that illustrate linking a first account 131 with a second account 132. To enable transfers from first account 131 to second account 132, an account owner may send a request to link first account 131 with second account 132. The request may be sent from user device 108 that is registered to an account owner, where the request may be received by one or more of financial institution 106 and third-party service provider 110. The request may include a request from first account 131 to second account 132 via user device 108, seeking authorization from the owner of second account 132 to provide access to transaction data, account details, and/or other information pertaining to second account 132. In some embodiments, the owner (or joint owner) of the first account and the second account are the same person. The request may be transmitted to a user device 108 registered with second account 132 for the owner of second account 132 to review. The request may include details on information to be shared, authorization to do so, and legal waivers for sharing personal and account details with a third-party. In response, owner of second account 132 may authorize, via user device 108 and graphical user interface 118, the request to link first account 131 with second account 132. The authorization may be sent back to third-party service providers 110 and/or financial institution 106, which will link accounts and enable information sharing between owners of first account 131 and second 132.

The ability to monitor transactions in first account 131 from second account 132 enables the owner of second account 132 to verify certain deposits, whether transferred funds are maintained for a period of time, and to monitor and track savings (and transferred funds) in first account 131. In the present embodiment, automatic electronic transfers are made from second account 132 to first account 131 based on activity in first account 131. Therefore, the owner of second account 132 may be provided information, including transaction details and periodic statements, related to activity in first account 131. The owner of second account 132 may then verify that rules are being applied correctly and that transferred funds to first account 131 are transferred and maintained according to preset rules governing the funds transfer. Particular rules with respect to transfers will be discussed below.

FIGS. 2A-2D show various implementations in which financial institution 106, third-party service provider 110, and user device 108 may be arranged in system 100. In FIG. 2A, first account 131 and second account 132 may be maintained within a common financial institution 106. First account 131 and second account 132 may have differing or overlapping account ownership. Third-party service provider 110 may be a third-party entity acting as an information clearing house or intermediary between financial institution 106 and user device 108, retrieving certain data from financial institution 106 and selectively providing data to account owners via one or more user devices 108.

In FIG. 2B, first account 131 and second account 132 may be maintained within separate financial institutions 106, 116. As noted above, first account 131 and second account 132 may have differing, overlapping, or identical account ownership. As with FIG. 2A, third-party service provider 110 may be a third-party entity acting as an information clearing house or intermediary between financial institutions 106, 116, and one or more user devices 108.

In FIG. 2C, first account 131 and second account 132 may be maintained within a common financial institution 106 and involve differing, overlapping, or identical account ownership. In this embodiment, financial institution 106 may communicate directly with account owners via user device 108, without third-party service provider 110. In FIG. 2D, first account 131 and second account 132 may be maintained within different financial institutions 106, 116, involve differing, overlapping, or identical account ownership, and financial institutions 106, 116 may communicate directly with account owners via user devices 108, without third-party service provider 110.

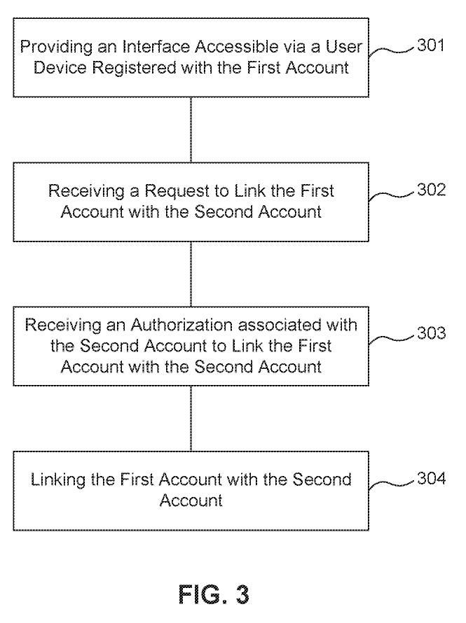

FIG. 3 provides a flow chart illustrating an embodiment of the disclosed methods for linking financial accounts to securely transfer funds from a first account to a second account based on activity in the second account. In some embodiments, one or more processors of, for example, financial institution 106, may execute instructions encoded on a computer-readable storage medium to perform steps of linking first account 131 to second account 132. It should also be understood, however, that one or more steps of linking accounts may be implemented by other components of system environment 100 (shown or not shown), including components of user device 108, third-party service provider 110, and/or network 102.

At step 301, financial institution 106 and/or third-party service provider 110 may provide graphical user interface 118 accessible to user device 108 that is registered with one or more of first account 131 and second account 132. For example, an account owner of first account 131 may register his or her user device 108 with financial institution 106 and/or third-party service provider 110. Upon registration, graphical user interface 118 may be provided via user device 108 for the owner to view first account 131 and to initiate requests to link first account 131 with other accounts (e.g., second account 132). In particular, user device 108 may receive requests via graphical user interface 118 to link first account 131 with second account 132, wherein user device 108 may send requests for information pertaining to second account 132, together with the request to link first account 131 with second account 132, to one or more of financial institution 106 or third-party service provider 110.

At step 302, financial institution 106 and/or third-party service provider 110 may receive a request to link first account 131 with second account 132 via graphical user interface 118 of user device 108. In certain embodiments, the request may also be received from another financial institution and/or third-party service provider 110 after being generated from user device 108. The request to link accounts may be initiated from either one of first account 131 or second account 132 via a registered user device 108. The request to link accounts may include information about each of first account 131 and second account 132, including identifiers for these accounts and details related to account ownership. The request may be processed by one or more of financial institution 106 or third-party service provider 110 to determine whether the accounts can be linked and if sufficient information has been provided to link accounts. Financial institution 106 or third-party service provider 110 may, upon receipt of the request to link accounts, send additional requests to other systems and servers to compile data for each account. For example, financial institution 106 or third-party service provider 110 may place restrictions on the ability to link accounts, such as having different owners, having overlapping owners, based on the account types, based on preset restrictions on particular accounts, etc.

Once financial institution 106 and/or third-party service provider 110 has determined that first account 131 and second account 132 are eligible to be linked, financial institution 106 and/or third-party service provider 110 may send an authorization to link the accounts to one (or more) owners of first account 131 and second account 132. For example, the authorization request may notify account owner of second account 132 via a user device 108 registered to second account 132, notifying the account owner of the request from the owner for first account 131 to link accounts. The authorization request may be viewed on graphical user interface 118 of user device 108 and may include, for example, a listing of account information to be shared if accounts are linked, an authorization to link accounts, and legal waivers permitting financial institution 106 and/or third-party service provider 110 to share personal data and account details with other parties and account owners upon linking accounts. In response to the authorization request, the owner of second account 132 may transmit an authorization, via user device 108 and graphical user interface 118, to financial institution 106 and/or third-party service provider 110 at step 303. Upon receipt of the authorization, financial institution 106 and/or third-party service provider 110 may link first account 131 with the second account 132 at step 304.

Upon linking first account 131 with the second account 132 at step 304, certain information may be shared between owners of the two accounts. The shared information may be transmitted using a secure link, tunnel, portal, or any other known secure data transfer protocol known for securely sending data over a public or private network. The shared information may be transferred from financial institution 106 and/or third-party service provider 110 to user device 108 over network 102. Before accessing and/or displaying the shared information via user device 108, a user may be required to establish and enter credentials to log into an application on user device 108. Upon verifying the owner's identity and logging in via user device 108, graphical user interface 118 may provide access, for example, to information on activity of first account 131 to the owner of second account 132. The shared information may be viewed and/or queried from user device 108.

In some embodiments, third-party service provider 110 may act as an intermediary between financial institution 106 and user device 108. In this embodiment, third-party service provider 110 may collect and transmit requests to link accounts and authorizations to do so from user device 108. In addition, upon receiving an authorization from user device 108, third-party service provider 110 may send the authorization, together with a request to financial institution 106 to provide third-party service provider 110 access to the shared account information of the linked accounts. The shared information may then be provided from financial institution 106 to third-party service provider 110, acting as an intermediary, which in turn may then provide access to the shared information (or a subset thereof) to one or both owners of first account 131 and second account 132 via their respective user devices 108. The shared information may be shared using secure protocols between financial institution 106 and third-party service provider 110 in order to maintain information security of personal data and account information.

In some embodiments, sensitive account information and personal data may be obfuscated or not shared between linked accounts. For example, data pertaining to account activity and account ownership of first account 131 may be necessary to determine if a transfer is appropriate from second account 132. However, address information, social security information, particular details on debit transactions (e.g., spending habits), and other information may not be shared from financial institution 106 of first account 131 or may be obfuscated from any shared information before being displayed to user device of second account 132.

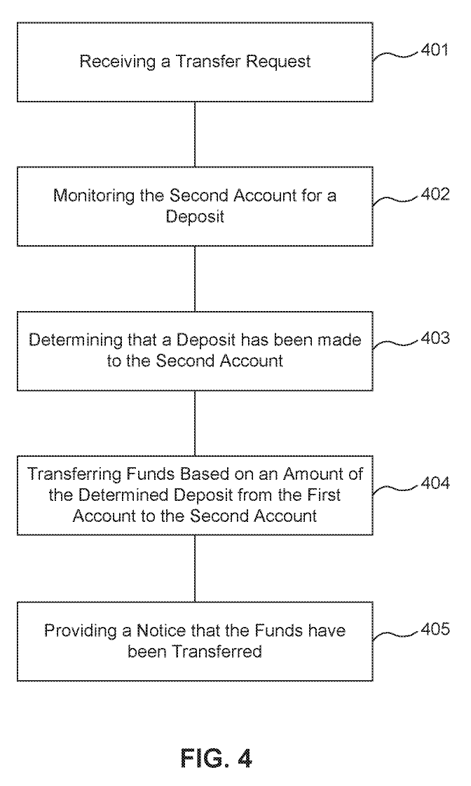

FIG. 4 provides a flow chart illustrating an embodiment of the disclosed methods for transferring funds between linked accounts based on activity in the one account. Once first account 131 and second account 132 are linked, one or more owners of first account 131 or second account 132 may submit, via user device 108 and graphical user interface 118, a request to transfer funds at step 401. The transfer request may include a request to initiate ongoing and automatic transfers of funds, for example, from second account 132 to first account 131 based on activity in first account 131. Activity may include, for instance, deposits, withdrawals, or any other form of activity in the account. The transfer request may include a number of rules associated with the request. The rules may establish, for example, when money is transferred from second account 132 to first account 131, how often transfers may occur within a time period, limits on the amount or frequency of transfers, how transfer amounts are determined, elections for one or both accounts to receive authorization requests for each transfer, elections for one or both accounts to receive notifications for each transfer, limits on how transferred funds may be used, how long the automatic transfer process will be in effect, what activity triggers for transfers, etc.

Financial institution 106 and/or third-party service provider 110 may receive the request to transfer funds from user device 108. Upon receiving the request to transfer funds, financial institution 106 may transfer funds based on the rules requested in the request. Financial institution 106 and/or third-party service provider 110 may also notify the owner of first account 131 of the request for transfer and obtain the owner's authorization to initiate the funds transfer according to the requested rules. The owner may accept, decline, or request certain rules be altered in response. The owner of second account 132 may then receive a notification of acceptance, decline, or alteration. Any alterations may also require approval by owner of second account 132.

Once the request for transfer has been accepted by financial institution 106 and/or third-party service provider 110, financial institution 106 and/or third-party service provider 110 may begin monitoring account activity in first account 131 at step 402. For each transaction in account 131, financial institution 106 and/or third-party service provider 110 may determine whether the transaction qualifies as a transaction that triggers a transfer of funds from first account 131 to second account 132, or vice versa. The rules established in the transfer request determine what transactions will trigger transfers and associated authorizations and notifications thereof. The monitoring process is an automated process that is accomplished, for example, by one or more processors of financial institution 106 and/or third-party service provider 110, whereby data related to each transaction (e.g., deposit, transfer, withdrawal, fee, etc.) is compared to the transfer request rules. If the transaction meets the qualifications of the established rules, a qualifying transaction is determined at step 403. The qualifying transaction, as noted, may be a qualifying deposit, withdrawal, fee, or any other type of transaction that fulfills the rules established by the transfer request.

At step 404, a qualifying transaction in second account 132 triggers a transfer of funds. For example, upon determining a qualifying deposit in second account 132, funds are transferred from first account 131 to second account 132 in an automatic process. In some embodiments, the transfer rules may require a transfer from second 132 to first account 131 for a qualifying transaction. In this embodiment, the rules may limit how funds transferred into second account 132 may be used, and, for example, early withdrawals of such funds may trigger a claw-back in which funds are transferred back to first account 131 from second account 132. Additional detail on specific rules will be provided below.

Before transferring funds, notifications and/or authorizations may be sent to one or more owner of first account 131 and second account 132. For example, upon determining a qualifying deposit in second account 132, an authorization to transfer funds may be sent to user device 108 registered with first account 131. The authorization notifies the owner (or owners) of first account 131 of the qualifying deposit in second account 132 and requests authorization to initiate the transfer at step 404. In response, the owner (or owners) may grant authorization via graphical user interface 118 of user device 108, in which a response is sent via network 102 to one or more of financial institution 106 and/or third-party service provider 110 to initiate the transfer. Likewise, the owner may decline the transfer in response. The same process may be provided to user device 108 registered with second account 132 before initiating the transfer at step 404. Further still, based on the rules established from the transfer request (or any intervening rules applied or changed via graphical user interface 118), notifications may be sent upon determination of a qualifying transaction and upon transfer of funds at step 405.

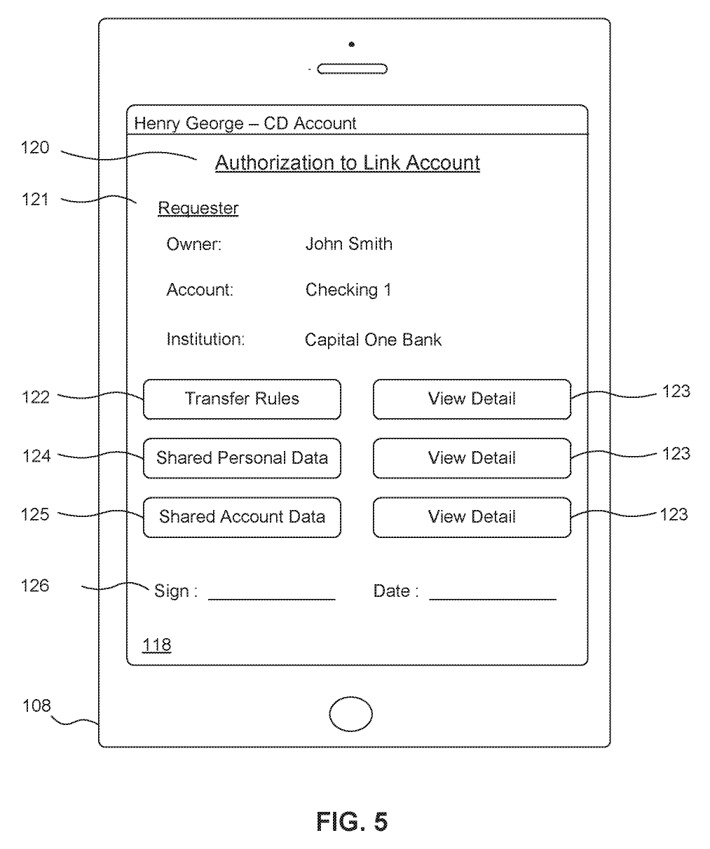

FIG. 5 provides an exemplary graphical user interface 118 displaying an authorization to link financial accounts on user device 108. Before first account 131 and second account 132 are linked by financial institution 106 and/or third-party service provider 110, an authorization request 120 is provided to one or more owners of the accounts to obtain authorization to link the accounts. In some embodiments, the authorization request 120 displays on graphical user interface 118 and provides information related to the request to link accounts received in step 302. Information pertaining to the requester 121 may be provided, the requester 121 being the party initiating the request to link accounts. The requested rules 122 associated with the funds transfer request may also be provided in the authorization request 120, or a link 123 thereof may be provided for the user of user device 108 (e.g., the account owner) to view all rules selected by the requester. In addition, the personal information 124 and account information 125 to be shared with the requester upon linking accounts may be provided, or links 123 to view the same.

The authorization request 120 may require the account owner to agree or decline the request. In some embodiments, the user may agree by selecting a button on the graphical user interface 118, digitally signing the user's name at a prompt 126, sliding a slide bar on the interface 118, or by any other means of indicating the owner authorizes the request. In some embodiments, the request may require the owner to log into an application on the user device 108 and/or provide credentials associated with the owner to authenticate the owner prior to receiving his or her authorization. In response to the authorization request 120, the account owner may agree, decline, or propose changes to the transfer rules 122, which will be sent back to the requester for approval before accounts are linked.

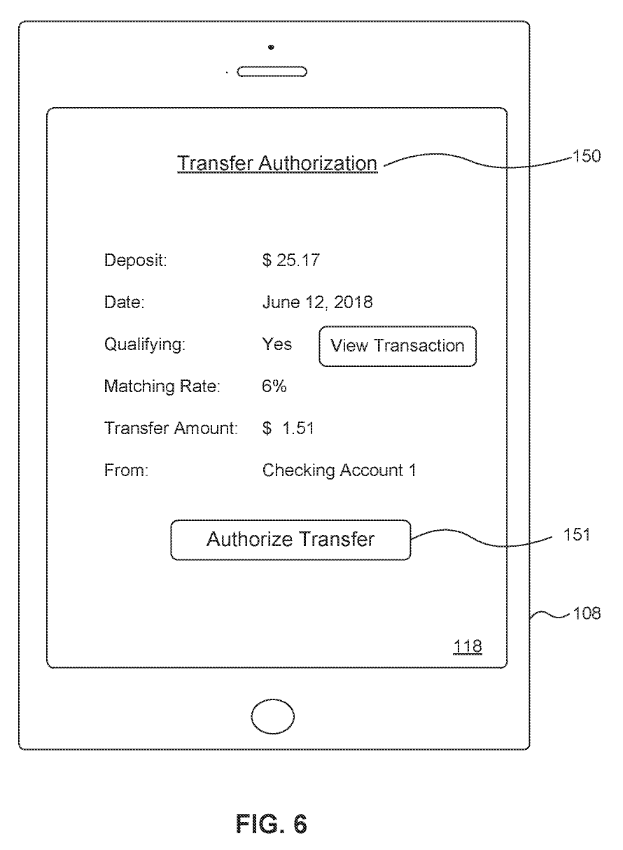

FIG. 6 provides an exemplary graphical user interface 118 displaying a transfer authorization 150 requesting funds to be transferred to another account based on activity in that account. In some embodiments, before funds are transferred from first account 131 to second account 132, a transfer authorization 150 may be provided to one or more of second account 132 or first account 131. For example, upon determining a qualifying transaction in first account 131 at step 403 and before transferring funds at step 404, a transfer authorization 150 may be sent requesting authorization to transfer funds. In this embodiment, funds are not automatically transferred upon determining a qualifying transaction. However, embodiments are contemplated in which the process of determining a qualifying transaction triggers an automatic transfer, dependent on other rules selected in the transfer request.

In one embodiment, the transfer authorization is sent by one or more of financial institution 106 and/or third-party service provider 110 over network 102 to user device 108 registered to second account 132. The transfer authorization 150 may include details of the qualifying transaction (e.g., deposit) in first account 131, the date of the qualifying transaction, details demonstrating the transaction qualifies under the selected transfer rules, the selected rules related to funds matching and transfer amount, and the account to be debited. Additional information may also be provided. In some embodiments, the transfer authorization 120 may require the user to agree or decline the transfer. In some embodiments, the user may agree by selecting a button 151 on the graphical user interface 118, digitally signing the user's name at a prompt, sliding a slide bar on the interface 118, or by any other means of indicating the owner authorizes the transfer. If the user authorizes the transfer, a response is sent to one or more of financial institution 106 and/or third-party service provider 110 over network 102, and the funds are transferred from second account 132 to first account 131 in the authorized amount.

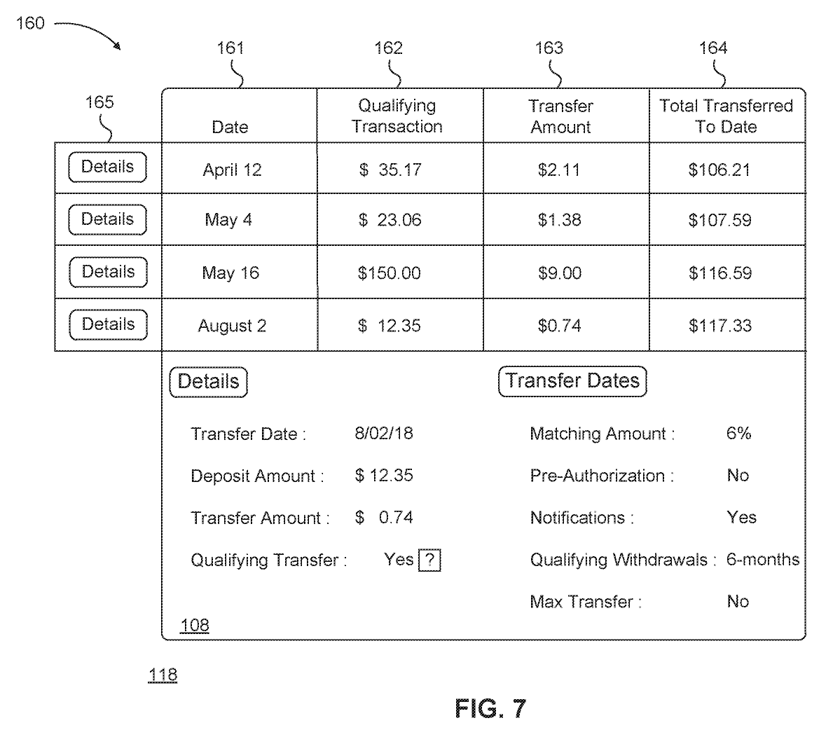

FIG. 7 provides an exemplary graphical user interface 118 displaying a summary of transfers and transfer rules based on activity in second account 132. In some embodiments, owner of first account 131 may have access to activity in second account 132, including transactions that are determined to be qualifying and that trigger a transfer from first account 131 to second account 132. In certain embodiments, the information provided to the owner of first account 131 may be less than all account information available to the owner of second account 132, based on the shared information agreed upon in the request for transfer. The ability to monitor account activity in second account 132 from first account 131 enables the owner of first account 131 to monitor and confirm transfers, confirm transactions are qualifying, and track the use of transferred funds over a period of time. Similarly, owner of second account 132 may have access to transfer rule and transfer activity information in first account 131, including transfers that are triggered by the activity from second account 132 (e.g., allowing the recipient owner of second account 132 to confirm that transfer rules are properly set up and that transfers from first account 131 have been made to second account 132). The information provided to the owner of second account 132 may be less than all account information available to the owner of first account 131, based on the shared information agreed upon in the request for transfer. In certain embodiments, graphical user interface 118 of user device 108 may display a chart, table, file, or other means of listing one or more transactions over a period of time.

The summary of transfers illustrated in the embodiment of FIG. 7 provides may be an interactive table 160 that summarizes transfers from first account 131 to second account 132 and activity in second account 132. In this embodiment, several columns may be provided, including those presenting a transaction dates 161, qualifying transactions 162, transfer amounts 163, and a running total of total funds transferred to date 164. Interactive table 160 may provide several options for the user to click, tap, or otherwise interact with the table in order to retrieve or display additional information for each transaction. For example, for each transaction, a details button 165 may be provided for the user to interact with in order to open a details screen 108 with more information than is provided in the columns and rows of the chart 160. In the details screen 168, information about a particular transaction may be provided, including details regarding the transaction, transaction (e.g., deposit) amount, the amount transferred from first account 131 to second account 132 based on the transaction amount, and the established transfer rules governing the monitoring and transfer of funds between accounts.

Transfer rules may be selected and established when a transfer request is submitted and received from either owner of first account 131 or second account 132. Various transfer rules are contemplated. The transfer rules govern how second account 132 is monitored and when to trigger transfers, either to or from second account 132. In one embodiment, transfer rules may include monitoring second account 132 for qualifying deposits and initiating transfers from first account 131 to second account 132 based on the qualifying deposit. For example, the transfer rules for the linked accounts may establish a matching funds amount. A transfer is initiated from first account 131 to second account 132 when a qualifying deposit is received in first account 131, and the transfer amount matches the deposit amount up to certain percentage. For instance, if the transfer rules establish a matching rate of 6%, six dollars will be transferred to second account for every one hundred dollars.

The rules may place caps on the amount of funds that will be matched and/or transferred. In some embodiments, the transfer rules may establish a matching percentage in which transfers are matched up to a certain deposit amount. For example, the transfer rules may establish a 6% matching rule for each deposit up to $300. In addition, the transfer rules may establish a sum total of transfers over a given time period. For example, the transfer rules may establish a 6% matching for each deposit up to $300 and up to a total of $1,000 in deposits per month. Additional matching rules are contemplated that restrict how and when transfers are triggered. In some embodiments, the transfer rules may trigger a notification to one or all owners of first account 131 and second account, 132, and the transfer rules may further require the owner of first account 131 to authorize the transfer to second account 132 after a qualifying transaction is determined in second account 132. Alternatively transfers may be automatically triggered up to a transfer limit set by the transfer rules in the transfer request. The transfer request, as described above, is a request to initiate ongoing transfers based on a set of transfer rules. The transfer request may, in some embodiments, be canceled, modified, and/or replaced at any time by agreement by the owners of first account 131 and second account 132. In other embodiments, the transfer request may be unilaterally changes by either the owner(s) of first account 131 or second account 132. The notifications and/or authorizations provided upon determining a qualifying transaction in second account 132 may indicate the details of the transaction in second account 132 and the source of funds for the transfer (e.g., first account 131).

The transfer rules may further establish what constitutes a qualified transaction in second account 132. For example, the transfer rules may place limitations on the type of transfer that triggers a transfer from first account 131. Qualifying transactions may include certain types of deposits, to the exclusion of all others. For instance, a cash deposit up to a certain limit may be a qualifying transaction, but a direct deposit from an employer may not be. The qualifying transaction rules enable transfers from first account 131, for example, that promote personal savings contributions to second account 132, while excluding normal pay deposits. Other embodiments are also contemplated, including limiting qualifying transactions by the source of funds, when the transaction occurs, the amount of the transaction, etc. Withdrawals may also be included or excluded as a qualifying transaction triggering a transfer. For example, certain withdrawals from second account 132 may be established as qualifying over others that are not. Qualifying withdrawals may include, for example, withdrawals for paying certain items (e.g., payments to book stores, to certain food stores, on a college campus, etc.), withdrawals to certain payees (e.g., payments to roommates or landlords for living expenses, etc.), withdrawals made from certain locations (e.g., at school, at a gas station, outside of a geographical region, etc.), and/or withdrawals made during certain times (e.g., during the school year, over the summer, etc.).

In addition, the transfer rules may establish limitations on how funds can be used in second account 132. For example, transfer rules may require transferred funds to be maintained in second account 132 for a predetermined period of time before the funds can be withdrawn or transferred. The predetermined period of time may be a time period from the day of transfer, and may further include rules goveming the funds associated with the initial qualifying transaction. For instance, the transfer rules may require the transferred funds and the funds that triggered the transfer to be maintained in second account 132 for a predetermined period of time. Different time periods may be provided, as well as exceptions and/or penalties for early withdrawal or transfer.

In some embodiments, if funds are requested to be withdrawn or transferred before the expiration of the time period set in the transfer rules, the request may be declined. In other embodiments, a notice may be provided to user device 108 registered to one or more of first account 131 and second account 132, notifying the users that an early request to withdraw or transfer funds is requested. The notification may notify one or more of the users that the request is declined, or an authorization request may be provided to the user device 108 registered to first account 131 to authorize the early withdrawal or transfer (e.g., against the preset transfer rules). User of user device 108 registered to first account 131 may then authorize or decline the withdrawal or transfer. In still other embodiments, funds may be withdrawn or transferred before the predetermined time period has expired, and upon doing so the transferred funds in second account 132 may be transferred back to first account 131 as an early withdrawal or transfer penalty. Other fines or fees may also be assessed. In some embodiments, user of user device 108 registered to first account 131 may authorize or waive the return transfer penalty via a notification sent to user device 108 when the request for withdrawal or transfer is received.

In some embodiments, a date identifier may be stored that is associated with the date the funds were transferred from first account 131 to second account 132. For example, the deposit date in second account 132 may be stored. Based on the transfer rules, the transferred funds and/or the funds that triggered the transfer may be monitored over a period of time in second account 132. One or more of financial institution 106 and/or third-party service provider 110 may then determine, based on the date identifier, that a withdrawal or transfer of the transferred funds or the funds that triggered the transfer is requested in second account 132 prior to the expiration of a predetermined time period after the deposit date. The request in second account 132 may be then be declined, or a request to authorize the early withdrawal or transfer may be sent to user device 108 registered to first account 131. Notices and/or authorization requests may be sent to user devices 108 registered with first account 131 and second account 132 during many stages of the disclosed methods, including, for example, at the time of qualifying transactions, transfers between accounts, certain withdrawal or transfer requests from second account, that portions of transferred funds are being transferred back to first account as an early withdrawal penalty, etc.

In some embodiments, transfer rules may place limitations on when transfers can be made from first account 131 to second account 132. For example, transfer rules may set a minimum balance in first account 131, below which no transfers will be triggered. The amount to be transferred may also be compared to the account balance of first account 131 in order to prevent overdrafts of first account 131. In some embodiments, upon determining a qualifying transaction has occurred in second account 132, it may be determined that first account 131 has insufficient funds or an account balance below a defined threshold to fund the requested transfer to second account 132. In those situations, the transfer may be declined and/or delayed until first account 131 has a sufficient balance to make the transfer. An amount identifier may be stored that indicates the amount of the funds to be transferred based on the qualifying transaction in second account 132. First account 131 may be monitored after storing the amount identifier, and a determination may be made at a later date or time that first account 131 has sufficient funds to transfer funds to the second account 132 in the amount of the amount identifier. Upon determining first account 131 has sufficient funds or is sufficiently funded, the transfer of the funds may be initiated from first account 131 to second account 132 based on the amount in the stored amount identifier. Alternatively, a request for authorization may be provided to user device 108 registered with first account 131, requesting authorization to transfer the funds from first account 131 to second account 132 at the later time.

In some embodiments, the transfer rules may limit the number of withdrawals of transferred funds and/or funds that triggered transfer from second account 132. For example, a withdrawal identifier may be stored indicating a number of withdrawals from second account 132. A maximum number of withdrawals (or transfers) out of second account 132 may be compared to the withdrawal identifier before authorizing the withdrawal or transfer. If it is determined, based on the withdrawal identifier, that a predetermined maximum number of withdrawals has been reached, and a request for withdrawal or transfer of the transferred funds (or funds that triggered the transfer) is detected from second account 132, the withdrawal or transfer request may be declined. Alternatively, a request to authorize the withdrawal or transfer may be sent to user device 108 registered to first account 131 to authorize the withdrawal or transfer above the predetermined maximum. The predetermined maximum may be set within a particular time window, for example, allowing a certain number of withdrawals or transfers in a month or quarter.

Overall, the disclosed embodiments provide new and novel methods and systems for linking financial accounts 130, regardless of account ownership and/or a financial institution 106 maintaining the particular financial accounts 130. Activity in a second account 132 can be monitored from a first account 131, while maintaining security of personal data and account information. Information may be shared over a secure network 102 via user device 108 and one or more financial institution 106 and/or third-party service provider. The ability to link accounts as described above enables a new type of transfer mechanism between disparate owners and institutions, while maintaining data security. The disclosed transfer methods enable automatic transfers from first account 131 based on activity in second account 132. The selectable transfer rules for the two linked accounts may enable automatic triggering of transfers and account monitoring. The methods may also provide secondary benefits, including facilitating a user to save funds in second account 132 by employing transfer rules that favor qualifying deposits. Additional secondary benefits may include providing family members with a savings or certificate of deposit account where deposited funds are matched by another family member's account, enabling ongoing savings and educating owners of the importance of saving money. Other secondary benefits may also be achieved.

In some embodiments, some or all of the logic for the above-described techniques may be implemented as a computer program, as an application, or as a plug-in module or sub-component of another application. The described techniques may be varied and are not limited to the examples or descriptions provided. In some examples applications may be developed for download to mobile communications and computing systems, e.g., laptops, mobile computers, tablet computers, smartphones, etc., being made available for download by the customer either directly from the device or through a website.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified or combined, and/or steps may be added or deleted.

Thus, the foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. For example, while a financial institution may have been described herein as the entity managing and/or maintaining the financial accounts 130 and providing the graphical user interface 118 for user device 108, it is to be understood that, consistent with disclosed embodiments, another entity may provide such services in conjunction with or separate from a financial institution. For example, third-party service provider 110 may provide some or all of the above-described functions.

The claims are to be interpreted broadly based on the language employed in the claims and not limited to examples described in the present specification. Accordingly, the examples presented herein are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples but, instead, are defined by the appended claims in light of their full scope of equivalents.

1-20. (canceled)

21. A system for securely linking a first account with a second account, comprising:
one or more memory devices storing instructions; and
one or more processors configured to execute the instructions to perform operations, comprising:
providing a first interface accessible via a user device registered with the first account, the first interface comprising a set of selectable rules for transferring funds to the second account;
receiving, via the first interface, a selection of a rule by a user associated with the user device, the selected rule comprising a withdrawal time period after a transfer date of a transferred fund from the first account to the second account;
providing a second interface accessible via a user device registered with the second account, the first account and second account being linked and the second account applying the selected rule;
receiving, via the first interface, a transfer request, the transfer request comprising a request to initiate an automatic transfer of funds from the first account to the second account when the second account receives a deposit;
providing, via the second interface, a notification indicating the transfer request;
monitoring the second account for a deposit;
determining that a deposit has been made to the second account;
upon detection of the deposit, transferring funds, based on an amount of the determined deposit and the selected rule from the first account to the second account;
providing, via the first interface, a first notice, the first notice stating that the funds have been transferred;
storing, into a database, a date identifier associated with the transferred funds, the date identifier indicating a transfer date of the transferred funds transferred into the second account;
determining, based on the date identifier, whether a withdrawal from the second account is requested prior to expiration of the withdrawal time period; and
electronically transferring, from the second account to the first account, the transferred funds based on a result of the determination that a withdrawal of the transferred funds from the second account is requested prior to expiration of the withdrawal time period.

22. The system of claim 21, wherein the selectable rules comprise setting an amount of funds transferred from the first account to the second account based on a percentage of the amount of the determined deposit.

23. The system of claim 21, wherein the selectable rules comprise presenting an authorization request via the first interface before initiating the funds transfer.

24. The system of claim 21, wherein:
the operations further comprise providing a notice, via the first interface, of the amount of the determined deposit, and
the notice further comprises a request for authorization, prior to transferring the funds, to initiate the transfer of funds from the first account to the second account.

25. The system of claim 21, wherein the selectable rules further comprise requiring the deposit be a qualifying deposit from a predetermined funds source.

26. The system of claim 21, wherein the selectable rules further comprise a maximum amount of funds that may be transferred from the first account to the second account within a predetermined time period.

27. The system of claim 21, wherein determining that a deposit has been made further comprises determining that a qualifying deposit from a predetermined funds source has been made.

28. The system of claim 21, wherein the operations further comprise:
determining, before transferring funds, that the first account has sufficient funds to permit the transfer the funds based on the amount of the determined deposit and the selected rule.

29. The system of claim 21, wherein the selectable rules further comprise specifying a minimum account balance required in the first account before transferring funds to the second account.

30. The system of claim 21, wherein the operations further comprise:
determining that the first account has insufficient funds to transfer funds to the second account; and
storing an amount identifier, the amount identifier indicating the amount of the funds to be transferred.

31. The system of claim 30, wherein the operations further comprise:
determining that the first account has sufficient funds for the transfer to the second account; and
initiating the transfer of the funds from the first account to the second account based on the stored amount identifier.

32. The system of claim 31, wherein the operations further comprise providing, via the first interface, a second notice, the second notice comprising:
an indication of sufficient funds in the first account;
the stored amount identifier; and
a request for authorization to transfer the funds from the first account to the second account.

33. The system of claim 21, wherein the operations further comprise:
declining the withdrawal request prior to the expiration of the predetermined time period after the transfer date.

34. The system of claim 21, wherein the operations further comprise:
providing, via the first interface, a withdrawal request notification, the withdrawal request notification comprising a request for authorization of the withdrawal.

35. The system of claim 21, wherein the operations further comprise:
providing, via the second interface, a fee indication specifying a fee associated with the withdrawal request.

36. The system of claim 21, wherein the operations further comprise:
providing a notice, via the second interface, indicating that the at least a portion of the transferred funds will be transferred from the second account to the first account.

37. The system of claim 21, wherein the operations further comprise:
providing, via the second interface, a third notice indicating the amount of transferred funds from the first account to the second account.

38. The system of claim 21, wherein the operations further comprise:
storing a withdrawal identifier, the withdrawal identifier indicating a number of withdrawals from the second account;
determining, based on the withdrawal identifier, that a predetermined maximum number of withdrawals has been reached;
detecting a request for withdrawal of the transferred funds from the second account; and
declining the withdrawal request.

39. The system of claim 21, wherein the operations further comprise:
storing a withdrawal identifier, the withdrawal identifier indicating a number of withdrawals from the second account;
determining, based on the withdrawal identifier, that a predetermined maximum number of withdrawals has been reached;
detecting a request for withdrawal of the transferred funds from the second account; and
providing via the first interface, a fourth notice, the fourth notice comprising a request for authorization of the withdrawal.

40. The system of claim 21, wherein the second account further comprises a certificate of deposit.
